(19) United States
(12) Patent Application Publication
(10) Pub. No.: US 2017/0061812 A1
(43) Pub. Date: Mar. 2, 2017

(54) DRIVER MONITORING AND FEEDBACK SYSTEM

(71) Applicant: KARZ SOFTWARE TECHNOLOGIES LTD., KFAR SABA (IL)

(72) Inventors: Danny LAHAV, Kfar Saba (IL); Alex LEVIT, Rehovot (IL)

(73) Assignee: KARZ SOFTWARE TECHNOLOGIES LTD., KFAR SABA (IL)

(21) Appl. No.: 15/252,799

(22) Filed: Aug. 31, 2016

Related U.S. Application Data
(60) Provisional application No. 62/212,702, filed on Sep. 1, 2015.
(60) Provisional application No. 62/212,703, filed on Sep. 1, 2015.

(51) Int. Cl. G09B 9/052; G09B 9/042; G06Q 40/08; B60Q 9/00; G07C 5/08; G08G 1/00

(52) U.S. Cl. CPC G09B 9/052; G07C 5/085; G08G 1/205; G06Q 40/08; B60Q 9/00; G09B 9/042

(57) ABSTRACT

A system, method, and non-transitory computer readable medium for automated driving performance feedback. The system includes a network interface for communicating at least with a driver user device, the driver user device including a plurality of sensors; a processing circuitry; and a memory, the memory containing instructions that, when executed by the processing circuitry, configure the system to: receive, from the driver user device affixed to a vehicle, sensor data captured by the plurality of sensors during a driving session; generate, based on the sensor data, at least one driving performance analytic; determine, based on the at least one driving performance analytic, at least one driving behavior event, wherein each driving behavior event is further determined based on at least one driving behavior threshold; generate, based on the at least one driving performance analytic and the at least one driving behavior event, a driving performance report for the driving session.

### CROSS-REFERENCE TO RELATED APPLICATIONS

This application claims the benefit of U.S. Provisional Patent Application No. 62/212,702 filed on Sep. 1, 2015, and 62/212,703 filed on Sep. 1, 2015, the contents of which are hereby incorporated by reference.

### TECHNICAL FIELD

The disclosure generally relates to a driving monitoring and feedback system, and more specifically to a driver monitoring and feedback system suitable for use in driving lessons, parental control and driving monitoring schemes.

### BACKGROUND

Monitoring and delivering feedback to drivers typically includes technology for sensing, sending, receiving, storing, presenting and reporting information relating to moving vehicles via telecommunication devices. Existing solutions usually include a combination of tracking devices that is able to determine location and acceleration in order to detect driving behavior and distracted driving, which can then be sent to a remote system for further processing and analysis.

Existing solutions for providing driving feedback typically require the installation of a standard tracking device, which is costly and also difficult to install. Some solutions use the vehicle's on-board diagnostics plug as the holder of such a tracking device. Some of these tracking devices use a dedicated communication link which is used only for the purpose of tracking the vehicle and, consequently, the driver. This communication link results in unnecessarily redundant computing resource usage, as every virtually driver today has a user device (e.g., a smartphone) that includes a communication link and multiple sensors to monitor driver behavior and, hence, track the vehicle.

Many parents, or driving instructors, ride in a vehicle with new drivers for 40 hours or more to provide the supervised practice required to get a driver's license. Most parents do a good job of teaching steering, accelerating, braking, controlling the vehicle, and parking. However, parents are not as experienced as professional driving instructors in providing objective feedback that measures driving skills, distracted driving, and driving behavior. Further, even professional instructors may have difficulty providing objective feedback, particularly due to their inability to simultaneously evaluate driving parameters such as speed, acceleration, turning radius, adherence to signs and signals, and the like, in real-time. Driving students and their instructors need effective and objective feedback on their progress so they can track improvement over time, emphasize training on specific skills and behaviors, and compare their progress to that of their peers.

Moreover, individual driving instructors provide feedback based on a limited number of personal experiences and, consequently, cannot provide a completely accurate gauge of each driving student's abilities in the context of other students. Like any students, driving students learn at different rates and respond better to some methods of teaching more than others. As a result, objective information on a driving student's relative progress would be useful for, for example, determining whether additional practice is needed for a particular driving student, determining whether the driving student is learning during the current lesson, and so on.

Additionally, although driving instructors are capable of giving feedback during lessons, such driving instructors are incapable of providing feedback related to fine adjustments during driving. For example, a driving instructor may be capable of determining that a driving student is going excessively fast in a residential neighborhood with a speed limit of 25 miles per hour if the student is driving at a speed of 40 miles per hour or more. However, the driving instructor cannot reasonably provide, in real-time, feedback related to fine adjustments of driving activity (e.g., slowing speed down from 30 miles per hour to 25 miles per hour).

Further, existing solutions do not automatically provide comprehensive reporting of driving performance to third parties (e.g., parents, instructors, insurance companies, legal authorities, and the like). Currently, such reporting is typically based on absence of accidents or tickets, which may not accurately reflect the driver's overall performance or address particular areas of improvement.

Therefore, it would be advantageous to provide a solution for automatic driver monitoring and feedback.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a system for automated driving performance feedback. The system includes a network interface for communicating at least with a driver user device, the driver user device including a plurality of sensors; a processing circuitry; and a memory, the memory containing instructions that, when executed by the processing circuitry, configure the system to: receive, from the driver user device affixed to a vehicle, sensor data captured by the plurality of sensors during a driving session; generate, based on the sensor data, at least one driving performance analytic; determine, based on the at least one driving performance analytic, at least one driving behavior event, wherein each driving behavior event is further determined based on at least one driving behavior threshold; generate, based on the at least one driving performance analytic and the at least one driving behavior event, a driving performance report for the driving session.

Certain embodiments disclosed herein also include a method for automated driving performance feedback. The method includes receiving, from a driver user device including a plurality of sensors, sensor data captured by the plurality of sensors during a driving session, wherein the driver user device is affixed to a vehicle; generating, based on the sensor data, at least one driving performance analytic; determining, based on the at least one driving performance analytic, at least one driving behavior event, wherein each driving behavior event is further determined based on at least one driving behavior threshold; generating, based on the at least one driving performance analytic and the at least one driving behavior event, a driving performance report for the driving session.

Certain embodiments disclosed herein also include a receiving, from a driver user device including a plurality of sensors, sensor data captured by the plurality of sensors during a driving session, wherein the driver user device is affixed to a vehicle; generating, based on the sensor data, at least one driving performance analytic; determining, based on the at least one driving performance analytic, at least one driving behavior event, wherein each driving behavior event is further determined based on at least one driving behavior threshold; generating, based on the at least one driving performance analytic and the at least one driving behavior event, a driving performance report for the driving session.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1 is a diagram of a driving monitoring and feedback system in accordance with one embodiment.

FIG. 2 is a diagram of a user device utilized in the driving monitoring and feedback system in accordance with one embodiment.

FIG. 3 is a flowchart of a method for monitoring driving performance and providing feedback according to an embodiment.

FIG. 4 is an input/output diagram illustrating an example determination of performance-related outputs based on sensory and other inputs.

FIG. 5 is an input/output diagram illustrating an example determination of grades based on performance-related outputs.

FIG. 6 is an example graph illustrating gyroscope data utilized according to an embodiment.

FIG. 7 is an example graph illustrating accelerometer data utilized according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein include a system and method for providing monitoring and feedback of driving performance. At least sensor data is received from a driver user device. Based on the sensor data, a plurality of performance analytics is determined. The performance analytics may be related to driving behavior (e.g., actions taken by the driver of the vehicle such as turning, braking, accelerating, parking, etc.), distracted driving (e.g., attention paid by the driver to controlling the vehicle), a combination thereof, and the like. Based on the performance analytics, a driving performance report is generated. The driving performance report may be sent to, e.g., the driver user device, a third party device, both, may be stored in a storage, or a combination thereof. In an embodiment, instructions for improving driving performance and, thus, to reduce the likelihood of car accidents, may be generated and sent, in real-time, to the driver user device.

The third party device may be utilized by a parent, an instructor, a fleet manager, an insurance investigator, a legal authority, or any other individual who may seek information indicating driving performance of a particular driver. Thus, the driving performance report may be utilized as, e.g., proof of fact for legal authorities in case of a car accident or crash, driving ticket, or “traffic court”. The driving performance report may also be provided to, for example, car management companies (e.g., fleets, taxis, car rental companies, and car sharing companies) and insurance companies. Additional uses of the report include proof of driving for defensive driving courses (in particular, state-approved defensive driving courses or driver improvement courses) and reduced insurance premiums for safe driving. Additionally, the driving performance report may be utilized for pay-as-you-go driving insurance plans, allowing drivers to pay for insurance based on, e.g., a duration of time or a distance in which the driver utilized the vehicle. Further, the driving performance report may be utilized for taxi and other paid driving services to track mileage or time spent driving.

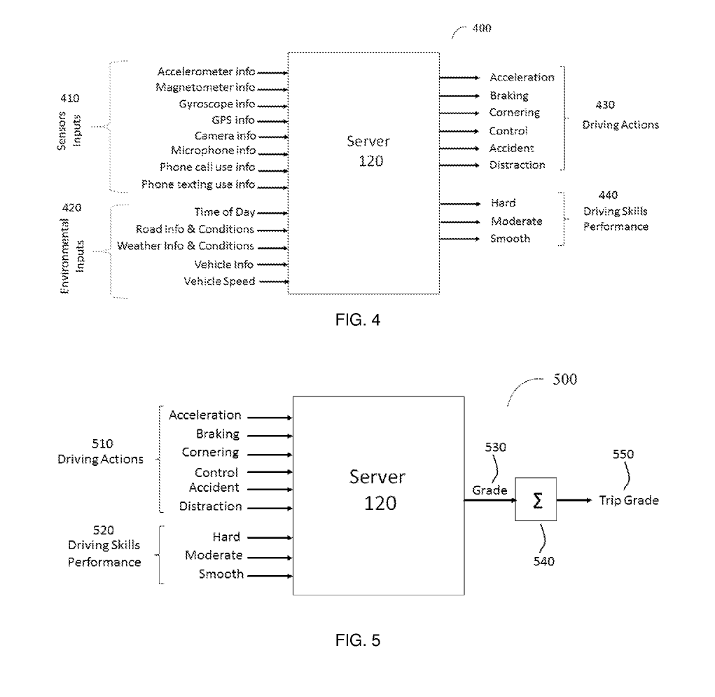

In an embodiment, in order to avoid continuous monitoring by an insurance company, only extreme driving behavior and distracted driving may be reported to the insurance company. As an example, driving sessions with a grade lower than a predetermined threshold may not be reported. Grading is discussed in more detail herein below with respect to FIGS. 4-7. The remaining reporting may include the number of hours the driver has driven, thereby allowing an insurance company to calculate the remaining driving hours or calculate an extra charge to the driver for additional driving hours in a pay-per-hour or pay-per mile insurance plan.

In an embodiment, the driving monitoring and feedback system is configured to update emergency responders such as police, fire departments, and ambulance services based on driving performance. In a further embodiment, the driving monitoring and feedback system is also configured to update the location of the vehicle and to identity the user of the user device in the vehicle. The update may be provided automatically based on one or more predetermined emergency rules (e.g., vehicle coming into contact with another vehicle at a speed of over 30 miles per hour), or may be provided in response to a request from, e.g., the driver, a passenger, an eye witness, and the like.

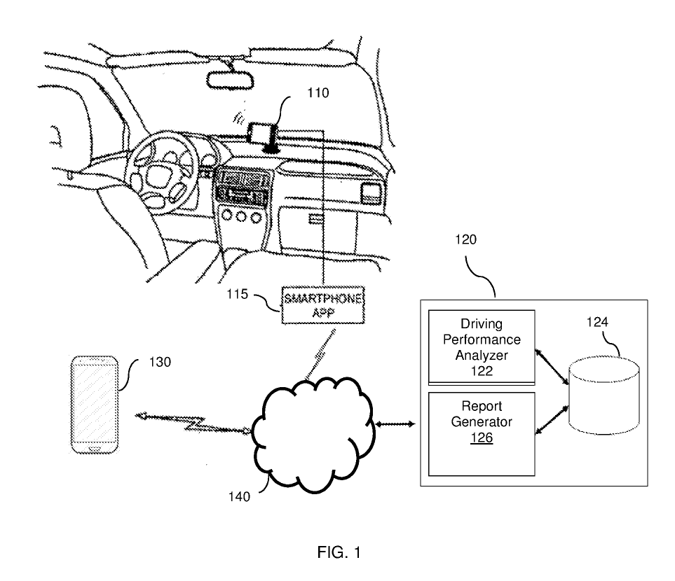

FIG. 1 is an example network diagram 100 utilized to describe the various disclosed embodiments. In an embodiment, a driving monitoring and feedback system may be utilized for driving lessons, parental control, driving monitoring, and accident prevention. The network diagram 100 includes a driver user device 110 configured with an application 115, a server 120, and a third party device 130 communicatively connected via a network 140. In an embodiment, the driver user device 110, the third party device 130, or each of the driver user device 110 and the third party device 130 may be, but is not limited to, a smartphone, a tablet computer, a wearable computing device, a vehicle information system, and the like. The third party device is typically utilized by an instructor, a parent, a fleet manager, a legal authority, an insurance investigator, or any other individual seeking driving performance information of the user of the driver user device 110. The network 140 may be, but is not limited to, a wireless, cellular or wired network, a local area network (LAN), a wide area network (WAN), a metro area network (MAN), the Internet, the worldwide web (WWW), similar networks, and any combination thereof.

The driver user device 110 is typically mounted or otherwise affixed to a portion of a vehicle. In the example shown in FIG. 1, the driver user device 110 is mounted on a dashboard of a car. The driver user device 110 may have installed thereon the application 115. The application 115 is configured at least to obtain sensor data captured by sensors (not shown) installed on the driver user device 110 and to send, to the server 120, the obtained sensor data. Such obtained sensor data may include, but is not limited to, images from a camera, accelerometer signals, GPS signals, gyroscope signals, a combination thereof, and the like.

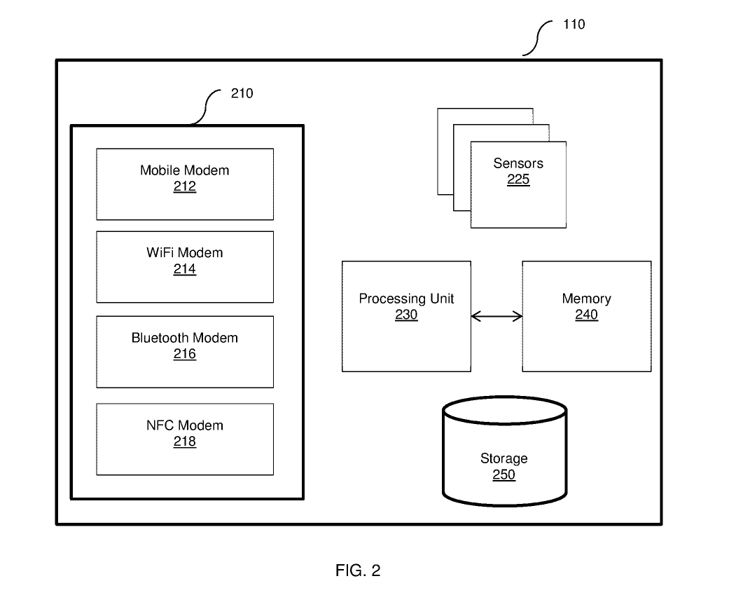

FIG. 2 is a block diagram of a driver user device 110 utilized according to an embodiment. The driver user device 110 includes a communication module 210 that further includes a mobile modem 212 for voice and data communication via a mobile network. In an embodiment, the driving student device 100 also includes a WiFi modem 214, a Bluetooth modem 216, and a near field communications (NFC) modem 218.

The driver user device 110 also includes a plurality of sensors 220. The sensors 220 may include, but are not limited to, an accelerometer, a gyroscope, a magnetometer, an GPS unit, a microphone, a camera, and a combination thereof. In an embodiment, the sensors 220 include a 3 axis accelerometer and a 3 axis gyroscope. The driver user device 110 further includes a processing unit 230 connected to a memory 240 and a storage 250. The storage 250 may be, but is not limited to, magnetic storage, optical storage, and the like, and may be realized, for example, as flash memory or other memory technology, CD-ROM, Digital Versatile Disks (DVDs), or any other medium which can be used to store the desired information.

The sensors 220 include at least one camera. Each camera may be, but is not limited to, a front camera (typically placed so as to face the road or other terrain in front of the vehicle) or a rear camera (typically placed so as to face the inside of the vehicle or otherwise placed so as to face the driver in or on the vehicle). The front camera is configured at least to capture images illustrating visual objects such as, but not limited to, road signs (speed limits, stop signs, etc.), road crossings, road conditions (e.g., school zones), behavior of surrounding vehicles (driving too closely, etc.), pedestrian positions, and empty parking lots. The front camera may further be configured to capture images illustrating driver behavior such as, but not limited to, lane departures and crossings, tailgating, rear end collisions, and the like. The rear camera is configured to identify potential visual signs of distracted driving such as, but not limited to, the driver looking away from the road (e.g., looking inside of the vehicle, looking in a direction not facing forward, etc.), animals in the car, eating, drinking, singing, drowsiness, fatigue, electronic device use, and the like. In an embodiment, the driver user device 110 may be configured to analyze images captured by the cameras of the sensors 220 to identify visual objects shown therein.

In an embodiment, the sensors 220 also include a microphone. The microphone is configured to identify potential audio signs of distracted driving such as, but not limited to, excessively loud music, singing, talking, animal noises, and the like.

Referring back to FIG. 1, the application 115 is configured to collect vehicle driving information gathered by sensors (e.g., the sensors 220) of the driver user device 110. The information collected from the sensors of the driving student device 100 is used to identify driving behavior, distracted driving, or both. The information may include, but is not limited to, accident detection, acceleration, braking, cornering, vehicle control, combinations thereof, and the like. In a further embodiment, the driver user device 110 is also configured to obtain weather data to be used as supporting metadata for the driving behavior and distracted driving information. Based on the obtained sensor and weather information, the driver user device 110 may be configured to identify driving events. The driving events further indicate a time of the event, a geographical location wherein the event occurred, or both. Geographical locations can be determined based on services such as, but not limited to, GPS, network location services, WIFI network mapping, and the like. The application 115 is configured to collect sensor data and to transmit the sensor data to the server 120.

Any or all of the sensor data can be sent at predetermined or flexible time intervals to the remote server 120 or can be stored, in real-time, in the storage 250, and sent in bulk at a later time. Sending the data periodically at the predetermined time intervals enables real-time monitoring and providing feedback to the driver user device 110, the third party user device 130, or to both. Such real-time monitoring and feedback may be further utilized to allow the driver to make driving adjustments in real-time. In an embodiment, sending the sensor data at flexible time intervals includes sending the sensor data only when a communication link having a communication speed above a predetermined threshold is available to the driver user device 110. In a further embodiment, the sensor data may be sent at predetermined time intervals unless the communication speed is below a predetermined threshold.

Alternatively or collectively, at least a portion of the sensor data may be analyzed locally on the driver user device 110. Thus, in another embodiment, the application 115 may be configured to analyze the sensor data to determine one or more of the driving events and to send data indicating the locally determined driving events to the server 120. In yet another embodiment, the application 115 may be configured to determine instructions for improving driving performance based on the sensor data analyzed locally by the application 115 and to cause a display or projection of the instructions in real-time.

In another embodiment in which the sensor data is sent at flexible time intervals, the application 115 may be configured to send the sensor data, driving events, or both, to the server 120 when a communication link having a communication speed above a predetermined threshold is available to the driver user device 110. In a further embodiment, the application 115 may be configured to determine driving events, to determine instructions for improving driving performance, or both, when a communication link having a communication speed above the predetermined threshold is not available. Performing the event or instruction determination via the application 115 when a sufficiently fast communication link is not available may allow for continuing provision of real-time feedback even when, e.g., the driver user device 110 cannot communicate with the server 120 in real-time.

Storing at least some of the information for subsequent bulk sending allows for conservation of computing resources, and may be utilized when, for example, particular information is not needed during driving. For example, information related to driving speed may be needed during driving if real-time instructions for improving driving performance are being provided, but information related to failing to stop at a red light may not be needed during driving. Thus, information related to speed may be sent in predetermined time intervals while information related to stop lights may be sent in bulk at a later time. In both cases, the information is temporarily stored locally in the local storage of the driver user device 110 and sent to the server 120 when a communication link to the server 120 is available. The remote communication is via the mobile network, local WiFi, Bluetooth, or any other type of communication between the driver user device 110 and the server 120.

In an embodiment, the application 115 is further configured to identify metadata indicating weather conditions to be used as supporting metadata for the driving behavior and distracted driving information and to send the weather condition metadata to the server 120 for processing. Alternatively or collectively, the application 115 may be configured to analyze the metadata to identify weather conditions. In another embodiment, the server 120 can retrieve such weather information from one or more data sources (not shown). Each of the data sources may be a web source including, but not limited to, a server of a weather reporting service. In an embodiment, the server 120 can be located in public or private data center or a public or private cloud such as, but not limited to, Amazon Web Services® (AWS), Google® Cloud Platform (GCP) or Microsoft® Azure.

The application 115 is configured to send data collected by the driver user device 110 to the server 120, to receive processed driving information such as events and indications from the server 120, to display the received information on a display of the driver user device 110, and to cause projection of audio notifications, warnings and instructions. The application 115 is further configured to cause a display of buttons utilized to set different commands for the server 120 such as, for example, beginning audio notifications, ceasing audio notifications, beginning real-time feedback, ceasing real-time feedback, and the like.

The information displayed on the display of the driver user device 110 received from the server 120 may include, but is not limited to, driving behavior and distracted driving events and event locations, driving route replays, instructions to rehearse the drive, or a combination thereof. This information may also be displayed on the third party device 130. In an embodiment, the instructions to repeat the drive may include repeating a driving route to compare information from similar drives to compare driver performance between attempts by the same driver. Subsequent drives may be rehearsed with different algorithms to improve detection of certain skills or behaviors or to weight certain skills or behaviors differently.

Information projected by the driver user device 10 typically includes instructions for improving driving performance and, therefore, to reduce the likelihood of an accident occurring. In particular, even for proficient drivers, a single moment of distracted, reckless, or otherwise improper driving can result in harmful accidents. Thus, the instructions for improving driving performance may both help new drivers learn to drive properly while reminding experienced drivers to remain diligent, thereby reducing the chances of vehicular accidents. The improvement instructions may be projected in real-time to prompt adjustment of driving behavior and distracted driving during driving sessions. For example, if the server 120 determines that a speed of the vehicle is above a posted speed limit of 50 MPH on a particular road, the projected instructions may include the statement “please slow down to less than 50 miles per hour.” Whether and which instructions to project may be determined based on, but not limited to, particular driving behavior and distracted driving events.

The driving behavior and distracted driving, routes, and events processed by the server 120 can be displayed as an overlay on a map displayed on the display of the driver user device 110, the third party device 130, or any other device with a display connectable to the server 120. Other audio, visual, or audiovisual notifications may be caused to be produced via the driver user device 110, the third party device 130, or both.

The server 120 includes a driving performance analyzer 122, a database 124, and a report generator 126. The driving performance analyzer 122 is configured to analyze the sensor data received from the driver user device 110 and to generate, based on the received sensor data, performance analytics for the driver. The performance analytics may be generated further based on data associated with other drivers. The sensor data of other drivers may be real sensor data (i.e., collected from other user devices), or may be simulated data based on ideal or otherwise model driving performance.

The performance analytics may include, but are not limited to, accident detection, acceleration, braking, turning speed and angle, vehicle control, and the like. In a further embodiment, the driving performance analyzer 122 is configured to filter the received sensor data to reduce measurement noise and fluctuations. Example filtering algorithms that can be utilized by the driving performance analyzer 122 may be, but are not limited to, a Butterworth low pass filter or a Kalman filter. Other types of filtering algorithms may be utilized in order to reduce measurement noise and fluctuations.

The driving performance analyzer 122 may be further configured to identify signs of distracted driving such as electronic device usage, looking away from the road, eating, drinking, loud music, animals, and the like. To this end, the driving performance analyzer 122 may be configured to analyze the images captured by the rear (i.e., facing the driver in or on the vehicle) camera(s) of the driver user device 110, the audio captured by the microphone of the driver user device 110, or both. The analysis of the images may further include imaging analysis to identify objects in the vehicle. As an example, analysis of portions of images captured by a camera facing the inside of the vehicle may result in identification of eyelids being shut frequently or for unusually long periods of time (i.e., indicating drowsiness) or location of the pupil in the eye (i.e., to determine whether the driver is looking at the road or elsewhere).

As a non-limiting example for generating a performance analytic, car acceleration on a road surface may be calculated based on two elements: X axis—forward/backward acceleration and Y axis—right/left acceleration (related to turns or road angles). Both acceleration elements affect vehicle acceleration translated to vector movement on the road. In a more general case, acceleration in the Z axis can also be included. The car acceleration vector size calculation formula may be:

Acceleration Vector=\sqrt{Accx²+Accy²}

Where:

Accx—Acceleration in axis X

Accy—Acceleration in axis Y

The driving performance analyzer 122 is further configured to analyze images captured by a camera of the driver user device 110. The image analysis may be further utilized in generating the performance report, the real-time instructions for improving performance, or both. Specifically, the analysis of the sensor data may be different depending on objects identified during the image analysis. For example, if analysis of an image results in identification of a school zone sign, a maximum allowed speed may be automatically reduced, and the performance analytics may be determined accordingly. As another example, if a stop sign is identified in an image, the analysis of the sensor data may include determining whether the vehicle stopped at the stop sign.

Each of the performance analytics may be further classified into a category indicating a relative degree of the analytic. The classifications may be based on one or more predetermined thresholds. For example, acceleration can be divided into three levels such as smooth acceleration, moderate acceleration, and hard acceleration. Further, smooth acceleration may be determined when acceleration is below a threshold of 5 feet per second squared, moderate acceleration may be determined when acceleration is between 5 feet per second squared and 15 feet per second squared, and hard acceleration may be determined when acceleration is above 15 feet per second squared. The same methodology can be applied to braking, turning speed and angle, vehicle control, and other performance analytics. In an embodiment, the categories separating the different levels can be based on predetermined thresholds. In another embodiment, the thresholds may be adaptive thresholds based on, but not limited to, vehicle weight and vehicle speed, or a mix of predetermined and adaptive thresholds.

In a further embodiment, each crossing of a threshold is determined as a driving behavior or distracted driving event, and may be associated with a time and a location. Each category of driving behavior or distracted driving may also be associated with a driving grade. The driving grades may be, but are not limited to, numerical values, and may be determined based on factors such as, but not limited to, environmental conditions (e.g., weather conditions, traffic conditions, etc.), age, vehicle make and model, and other factors affecting driving conditions. As a non-limiting example, acceleration may be set with the following grades: smooth acceleration is associated with a grade of 10, moderate acceleration grade is associated with a grade of 5, and hard acceleration grade is associated with a grade of −15 (negative 15). An overall driving behavior and distracted driving grade may be determined based on driving grades of each performance analytic. Further, each performance analytic driving grade may be weighted. Moreover, weight may be predetermined, or may be determined based on, e.g., driving performance. Weighting grades based on driving performance allows the server 120 to automatically emphasize particular aspects of driving. Determining driving performance grades is described further herein below with respect to FIGS. 4-7.

In an example embodiment, grades may be based on 4 groups: braking, acceleration, corner turning, and control. Each group can have the same weight (i.e., 25%), or adaptive weights can be utilized to emphasize specific behaviors and skills. For example, if the driver is using the brakes more frequently, the weight of braking can be set to 40% and the weight of each other group can be set to 20%. Thus, in this example, if braking by the driver is classified as hard breaking with a grade of 0, the maximum possible overall grade out of 100 may be 60. Alternatively, the grading weights may be determined based on relative numbers of graded actions for each group. As an example, the weights may be determined based on a number of times the brakes were used, a number of accelerations, a number of turns, and a number of instances of vehicle control for braking, acceleration, corner turning, and control, respectively.

The database 124 includes data related to the user of the driver user device 110, of other drivers, or both. The data may include sensor data, driving behavior and distracted driving classifications, driving events, performance analytics, driving performance reports, and the like. To this end, in an embodiment, the server 120 may be configured to store, in the database 124, the performance metrics or driving performance reports. In a further embodiment, the server 120 may be configured to store data in the database 124 in real-time during a driving session, thereby allowing for real-time generation and provision of feedback.

The report generator 126 is configured to analyze the sensor data, events, and grades stored in the database 124 and to generate a driving performance report indicating the grades and other performance-related information. Such performance-related information may be sent for display to the driver user device 110, the third party device 130, or both. The particular information sent may be determined based on, but not limited to, whether the information is being sent in real-time (i.e., only certain information may be reported in real-time), a request from the driver user device 110 or the third party device 130, a combination thereof, and the like.

The driving performance report may be further based on one or more driving restriction parameters received from the third party device 130. Example driving restriction parameters provided by the third party device 130 include, but are not limited to, a maximum driving speed, thresholds for classification, a maximum driving distance for a particular session, and the like. The driving performance report may indicate whether the driving parameters set by the third party device 130 are met for each driving session.

The third party device 130 may be configured to display the driving student's driving behavior, distracted driving, and status information. The driving information can be, but is not limited to, a current status of a driving session, driving performance over time, suggestions for improving driving, comparative driving performance (e.g., as opposed to other drivers), combinations thereof, and the like.

In an embodiment server 120 is further configured to provide information such as, but not limited to, the driving student driving behavior and distracted driving, driving route, location, speed, distance from home, and current driving status, to the third party device 130. This information may be utilized for remote monitoring of the driver using the driver user device 110.

The information collected by the application 115 and its resulting driving behavior and distracted driving are stored in the server 120. The stored information can be used as proof of fact of driving actions for legal authorities. For example, the information may be used as evidentiary support for accidents, driving tickets, traffic court, defensive driving courses (in particular, state-approved defensive driving courses), driving improvement courses, practical driving hours, and the like.

In an embodiment, the server 120 is further configured to detect accidents based on sensor data collected by the driver user device 110. An accident may be determined when, for example, an image captured by a camera of the driver user device 110 shows the vehicle physically touching another object (e.g., another vehicle, a tree, a sign, a pedestrian, etc.), when a speed of the vehicle decreases below a predefined threshold in a particular time period, a combination thereof, and the like. In a further embodiment, the server 120 may be configured to automatically trigger an automatic update to emergency responders such as police, fire departments, and ambulance services. Triggering the update may include, but is not limited to, sending a notification indicating the current geographical location of the vehicle and the identity of the driver. Alternatively or collectively, the emergency responders update may be triggered manually via the driver user device 110 or the third party device 130

In an embodiment, in order to avoid continuous monitoring, only extreme driving behavior and distracted driving may be reported to the insurance company, for example consecutive drives with a grade below a predetermined threshold. Reporting only extreme driving behavior and distracted driving conserves computing resources and allows parties viewing the driving performance reports to focus only on driving activities that are particularly dangerous or otherwise notable

The server 120 typically includes a processing circuitry (not shown) coupled to a memory (not shown). The processing circuitry may comprise or be a component of a processor (not shown) or an array of processors coupled to the memory. The memory contains instructions that can be executed by the processing circuitry. The instructions, when executed by the processing circuitry, cause the processing circuitry to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing circuitry may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be noted that FIG. 1 is described with respect to a database 124 included in the server 120 merely for simplicity purposes and without limitation on the disclosed embodiments. Alternatively or collectively, the server 120 may be communicatively connected to one or more external databases (not shown) including data related to driving performance of the user of the driver user device 110, of other drivers, or both.

It should be further noted that FIG. 1 includes one driver user device 110 and one third party device 130 merely for simplicity purposes and without limitation on the disclosed embodiments. A plurality of driver user devices, third party devices, or both, may be communicatively connected to the server 120 and may be provided feedback based on sensor data received from the driver user devices without departing from the scope of the disclosure. Further, each driver user device may be associated with one or more third party devices, only associated third party devices may be sent or otherwise access data related to a particular driver user device.

It should also be noted that FIG. 1 is described with respect to the server 120 analyzing the sensor data merely for simplicity purposes and without limitation on the disclosed embodiments. The driver user device 110 may analyze at least a portion of the sensor information without departing from the scope of the disclosure.

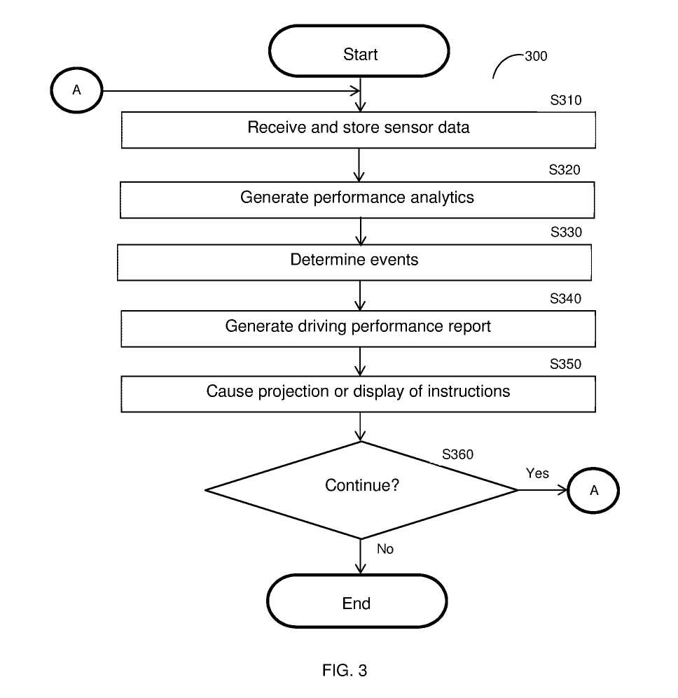

FIG. 3 is an example flowchart 300 illustrating a method for automatically providing driving performance feedback according to an embodiment. In an embodiment, the method may be performed by a server (e.g., the server 120) based on sensor information received from a driver user device (e.g., the driver user device 110) affixed to a vehicle.

At S310, sensor data is received with respect to a driving session (i.e., a trip in a vehicle). The sensor data may be received from the driver user device, a database including sensor data of other driver user devices, or both. The received sensor data may include, but is not limited to, images, accelerometer signals, GPS signals, gyroscope signals, magnetometer signals, audio, combinations thereof, and the like. In a further embodiment, S310 includes storing, in real-time, the received sensor data. In another embodiment, S310 may further include receiving metadata indicating, e.g., weather conditions during the driving session. The weather conditions may include, but are not limited to, temperature, rain or snow conditions, sun intensity, barometric pressure, presence of thunder storms, and the like.

In another embodiment, S310 may further include obtaining road information related to a road occupied by the vehicle during the driving session. The road information may be obtained based on a geographic location indicated in the sensor data and may include, but is not limited to, speed limit, locations of road signs (e.g., yield sign, stop sign, etc.), locations of school zones, locations of road work currently being performed, and the like.

At S320, at least one performance analytic is generated based on the received sensor data, the received metadata, the obtained road information, or a combination thereof. The at least one performance analytic may indicate driving performance information such as, but not limited to, driving speed, acceleration, turning speed, turning angle, and the like.

In a further embodiment, S320 may include determining, based on the sensor data, at least one grade indicating the driver's performance. In yet a further embodiment, the grades may be relative grades based on, but not limited to, past driver performance, the weather conditions during the driving session (e.g., a grade may be higher when weather conditions are rainy, windy, or icy than when weather conditions are sunny and clear), driving performance of other drivers (i.e., indicated by the sensor data of other driver user devices), and the like.

At S330, at least one driving event is determined on the at least one performance analytic, the sensor data, or both. In an embodiment, the driving events may be determined based on the determined grades. For example, a driving event may be determined when a grade is below a threshold (e.g., a predetermined threshold).

In an embodiment, S330 further includes imaging analysis of images captured by the driver user device. Based on the imaging analysis, one or more road objects may be identified. The identified road objects may include, but are not limited to, traffic signs (e.g., stop signs, speed limit signs, etc.), pedestrians, other vehicles, trees, road dividers, road markings (e.g., painted lines), and the like.

At S340, based on the determined events and generated performance analytics, a driving performance report is generated. The driving performance report may be sent to a user device (e.g., the driver user device or a user device of a third party), stored for subsequent access, or both.

At optional S350, at least one instruction for improving driving performance is determined based on the driving performance report. In an embodiment, S350 further includes causing, in real-time, a projection of audio including the at least one instruction, a display of the at least one instruction, or both, on the driver user device. The real-time projections or displays may act as a substitute for a driving instructor.

At S360, it is determined whether additional sensor data has been received and, if so, execution continues with S310; otherwise, execution terminates.

FIG. 4 is an example input/output diagram 400 illustrating example inputs and outputs for the server 120 utilized according to an embodiment. The example diagram 400 illustrates an analysis of sensor inputs 410 combined with environmental inputs 420 to determine driving actions 430 and driving skills performance 440.

In the example diagram 400, the sensor inputs 410 include accelerometer data, magnetometer data, gyroscope data, GPS data, camera data, microphone data, phone call usage data, and phone texting usage data. The example environmental inputs 420 include a time of day, road information and conditions, weather information and conditions, vehicle information (e.g., make, model, age, etc.), vehicle speed, and the like. The road information and conditions may be determined based on identification of road objects in images captured by the driver user device 110. The example driving actions 430 include acceleration, braking, cornering (i.e., turning speed and angle), vehicle control, any accidents that occurred during a drive, and distraction. The example driving skills performance 440 include the classifications hard, moderate, and smooth.

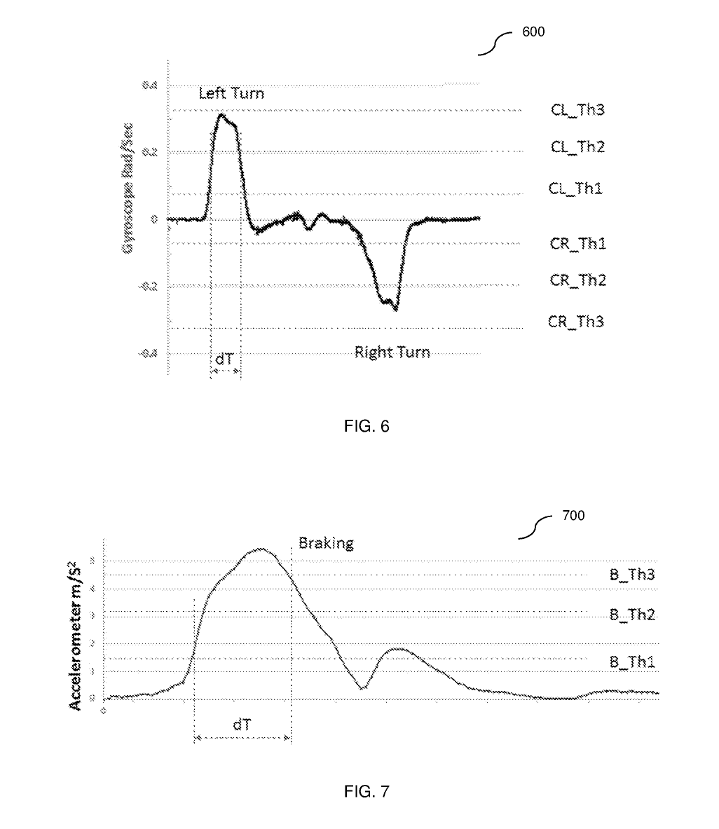

The server 120 may be configured to determine the driving actions 430 and the driving skills performance 440 based on predetermined thresholds as discussed further herein below with respect to FIGS. 6-7.

The predetermined thresholds may be further selected or otherwise adapted based on the environmental inputs 420. Specifically, the server 120 may be configured to adjust, based on the environmental inputs 420, each predetermined threshold to be applied on the sensor inputs 410. As a non-limiting example, a maximum permissible speed can be set based on road maximum speed and adjusted based on environmental conditions. A maximum speed of 80 Km/hr on a sunny day can be reduced to 60 Km/hr or 40 Km/hr in case of light rain or heavy rain, respectively, or to 30 Km/hr in case of snow. The thresholds may be similarly adapted for cornering, acceleration, braking, and control.

FIG. 5 is an example input/output diagram 500 illustrating grading performed by the server 120 according to an embodiment. In the example diagram 500, driving actions 510 and driving skills performance 520 are utilized as inputs. In an embodiment, the driving actions 510 and the driving skills performance 520 may be determined as described further herein above with respect to FIG. 4. The output based on the driving actions 510 and the driving skills performance 520 includes grades 230. The accumulation function aggregates the grades 230 into an overall performance grade 250.

In an embodiment, each of the driving actions 510 is weighted for determining the overall performance grade 250. As a non-limiting example, it is possible to set an equal weight per each driving action—in this example, 25% each. An example for a different scheme to focus on acceleration and braking can set the weight for acceleration to 30%, for braking to 30%, for cornering to 20%, and for control to 20%. In this example, repeated instances of hard acceleration and hard braking will reduce the overall grade more than repeated instances of poor cornering or vehicle control. In an embodiment, the accident driving action can be considered as a driving grade zero, i.e., if an accident occurs, the driving performance grade for accident may be zero. In the case of using greater or fewer driving actions, the control driving action is not considered in the grade calculation and the weight distribution is rearranged accordingly. The case is similar to adding additional driving actions such as stopping at a stop sign. Adding such driving skills will rearrange the weight allocation.

As an example, the per driving action weights may be defined as follows:
W_{ACC}: Acceleration Weight
W_{BRK}: Braking Weight
W_{COR}: Cornering Weight
W_{CON}: Control Weight
W_{DIS}: Distraction Weight

The driving skills performance inputs 220 may be utilized to distribute points or grades per driving session. Using the non-limiting example of three levels, the points set for each level are as follows: Hard is (−20), Moderate is (+5), and Smooth is (+20). The accumulation function 240 accumulates the driving skill performance points for the grade 230 per driving action. In the case of a negative accumulation result, based on the scheme the grade 230 can be truncated to zero or can be kept negative to reduce the overall driving performance grade 250.

Thus, in a further example, the individual driving grades may be calculated as follows:

$$Acceleration Performance grade \text{:} {W}_{ACC} * {Σ}_{i = 1}^{{N}_{ACC}} {ACC}_{p}$$

$$Braking Performance grade \text{:} {W}_{BRK} * {Σ}_{i = 1}^{{N}_{BRK}} {BRK}_{p}$$

$$Cornering Performance grade \text{:} {W}_{COR} * {Σ}_{i = 1}^{{N}_{COR}} {COR}_{p}$$

$$Control Performance grade \text{:} {W}_{CON} * {Σ}_{i = 1}^{{N}_{CON}} {CON}_{p}$$

$$Distraction Performance grade \text{:} {W}_{DIS} * {\sum }_{i = 1}^{{N}_{DIS}} {DIS}_{p}$$

where N_{ACC}=number of acceleration actions, ACC_{P}=per acceleration action performance level, N_{BRK}=number of braking actions, BRK_{P}=per braking action performance level, N_{COR}=number of cornering actions, N_{ADT}=number of accidents, COR_{P}=per cornering action performance level, N_{CON}=number of control actions, CON_{P}=per control action performance level, and ADT_{P}=per accident action performance level. The overall driving performance grade may be therefore calculated as follows:

$$G = {G}_{0} + {W}_{ACC} * {\sum }_{i = 1}^{{N}_{ACC}} {ACC}_{p} + {W}_{BRK} * {\sum }_{i = 1}^{{N}_{BRK}} {BRK}_{p} + {W}_{COR} * {\sum }_{i = 1}^{{N}_{COR}} {COR}_{p} + {W}_{CON} * {\sum }_{i = 1}^{{N}_{CON}} {CON}_{p} + {W}_{DIS} * {\sum }_{i = 1}^{{N}_{DIS}} {DIS}_{p}$$

where G=individual driving grade, and G₀ is a grade bias value. The grade bias value can be used to adjust the overall grade, for example in case the accumulation of the action performance level is negative. In the case of grades per segment, the total grades per segment are accumulated for the overall driving performance grade. In some embodiments, in the event of an accident, the overall driving performance grade for the accident parameter may be determined to be 0.

It should be noted that FIGS. 4 and 5 are described herein above with respect to inputs and outputs to and from the server 120, respectively, merely for simplicity purposes and without limitation on the disclosed embodiments. As noted above, in an embodiment, part or all of the analysis may be performed via the user device 110 (e.g., by the application 115). In particular, performing part or all of the analysis via the application 115 may be useful for ensuring real-time provision of feedback. As a non-limiting example, the application 115 may analyze images captured by a camera of the user device 110, and may identify a stop sign within 100 feet. Based on the analysis, the application 115 may cause projection of an audio instruction that the driver is approaching a stop sign in real-time, thereby alerting the driver to the upcoming stop sign.

FIG. 6 is an example graph 600 illustrating sensor data captured by a gyroscope according to an embodiment. The example graph 600 illustrates a left turn and a right turn as indicated by gyroscope data during a driving session. Specifically, the left turn and right turn are determined based on gyroscope signals above a predetermined threshold and below a predetermined threshold, respectively. In the example shown in graph 600, thresholds CL_Th1, CL_Th2, and CL_Th3 are utilized for determining whether a left turn has occurred, and thresholds CR_Th1, CR_Th2, and CR_Th are utilized for determining whether a right turn has occurred. Which thresholds are utilized may be determined based on environmental conditions (e.g., weather conditions, school zones, etc.) and personal factors (e.g., age).

FIG. 7 is an example graph 700 illustrating sensor data captured by an accelerometer according to an embodiment. The graph 700 illustrates braking as indicated by accelerometer data during a driving session. Specifically, acceptable levels of braking are determined based on one of the thresholds B_Th1, B_Th2, or B_Th3. Which thresholds are utilized may be determined based on environmental conditions (e.g., weather conditions, school zones, etc.) and personal factors (e.g., age).

It should be noted that various example embodiments are described with respect to particular units of measurement merely for simplicity purposes and without limitation on the disclosed embodiments. Any applicable form of measurement may be utilized. For example, speed may be measured in miles per hour, kilometers per hour, or any other measurement of distance by time.

It should be noted that various embodiments described herein are discussed with respect to a parent or instructor accompanying the driver merely for simplicity purposes and without limitation on the disclosed embodiments. Other individuals may ride in the vehicle in addition to or instead of a parent or instructor without departing from the scope of the disclosure. Further, it should be noted that no parent or instructor is required, and the driver may be the sole occupant of the vehicle without departing from the disclosed embodiments. In particular, a third party may be provided or otherwise allowed to access feedback information including any driving performance reports for subsequent debriefing.

Even further, it should be noted that various embodiments disclosed herein are discussed with respect to cars merely for simplicity purposes and without limiting the disclosed embodiments. Other vehicles or forms of locomotion, both now known and hereinafter developed, may be equally utilized without departing from the scope of the disclosure. As a non-limiting example, the disclosed embodiments may be applied to provide monitoring and feedback of driving activity for a user of a motorcycle. Moreover, the feedback may be specifically based on driving activity of drivers of the same or similar vehicles. For example, for a motorcycle rider, any feedback may be based only on driving performance of other motorcycle riders. This allows for, e.g., performance feedback that accounts for differences in best practices for different vehicles (e.g., different traffic rules may apply to large trucks than to cars).

It should be also noted that various uses for driving performance reports generated according to the disclosed embodiments are described herein merely as examples and without necessarily limiting the disclosed embodiments. Unless claimed, such example uses are not required do not limit any of the various disclosed embodiments. For example, a driving performance report may be provided to a user device for use as legal evidence, for insurance purposes, or for post-driving session reviews, but these example uses are not required or otherwise limiting unless included as features in the claims.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure. Furthermore, the foregoing detailed description has set forth a few of the many forms that the disclosed embodiments can take. It is intended that the foregoing detailed description be understood as an illustration of selected forms that the disclosure can take and not as a limitation to the definition of the disclosed embodiments.

What is claimed is:

1. A system for automated driving performance feedback, comprising:
a network interface for communicating at least with a driver user device, the driver user device including a plurality of sensors;
a processing circuitry; and
a memory, the memory containing instructions that, when executed by the processing circuitry, configure the system to:
receive, from the driver user device affixed to a vehicle, sensor data captured by the plurality of sensors during a driving session;
generate, based on the sensor data, at least one driving performance analytic;
determine, based on the at least one driving performance analytic, at least one driving behavior event, wherein each driving behavior event is further determined based on at least one driving behavior threshold;
generate, based on the at least one driving performance analytic and the at least one driving behavior event, a driving performance report for the driving session.

2. The system of claim 1, wherein the sensor data includes at least one of: images, audio, magnetometer signals, accelerometer signals, global positioning system signals, and gyroscope signals.

3. The system of claim 1, wherein the system is further configured to:
receive metadata from the driver user device, wherein the metadata indicates at least weather conditions during the driving session, wherein the driving performance report is generated further based on the received metadata.

4. The system of claim 1, wherein at least a portion of the sensor data is stored locally on the driver user device during the driving session, wherein the locally stored at least a portion of the sensor data is received after the driving session.

5. The system of claim 1, wherein the system is further configured to:
store, in real-time, the at least one driving performance analytic.

6. The system of claim 1, wherein the driving performance report is generated further based on a plurality of driving performance analytics associated with other driver user devices.

7. The system of claim 1, wherein the system is further configured to:
determine, based on the driving performance report, at least one instruction for improving driving performance; and
cause, via the driver user device, at least one of: an audio projection of the at least one instruction, and a display of the at least one instruction.

8. The system of claim 1, wherein the system is further configured to:
generate, based on the at least one driving performance analytic, at least one driving grade, wherein the driving performance report is generated further based on the at least one driving grade.

9. The system of claim 8, wherein the system is further configured to:
determine, for each driving grade, whether the driving grade is below a threshold, wherein each driving grade is indicated in the driving performance report only if the driving grade is below a threshold.

10. The system of claim 1, wherein the system is further configured to:
determine, based on the at least one driving behavior event, whether an accident occurred; and
upon determining that an accident occurred, send a notification to at least one emergency responder service, wherein the notification indicates at least a location of the accident.

11. A method for automated driving performance feedback, comprising:
receiving, from a driver user device including a plurality of sensors, sensor data captured by the plurality of sensors during a driving session, wherein the driver user device is affixed to a vehicle;
generating, based on the sensor data, at least one driving performance analytic;
determining, based on the at least one driving performance analytic, at least one driving behavior event, wherein each driving behavior event is further determined based on at least one driving behavior threshold;
generating, based on the at least one driving performance analytic and the at least one driving behavior event, a driving performance report for the driving session.

12. The method of claim 11, wherein the sensor data includes at least one of:
images, audio, magnetometer signals, accelerometer signals, global positioning system signals, and gyroscope signals.

13. The method of claim 11, further comprising:
receiving metadata from the driver user device, wherein the metadata indicates at least weather conditions during the driving session, wherein the driving performance report is generated further based on the received metadata.

14. The method of claim 11, wherein at least a portion of the sensor data is stored locally on the driver user device during the driving session, wherein the locally stored at least a portion of the sensor data is received after the driving session.

15. The method of claim 11, wherein the system is further configured to:
store, in real-time, the at least one driving performance analytic.

16. The method of claim 11, wherein the driving performance report is generated further based on a plurality of driving performance analytics associated with other driver user devices.

17. The method of claim 11, further comprising:
determining, based on the driving performance report, at least one instruction for improving driving performance; and
causing, via the driver user device, at least one of: an audio projection of the at least one instruction, and a display of the at least one instruction.

18. The method of claim 11, further comprising:
generating, based on the at least one driving performance analytic, at least one driving grade, wherein the driving performance report is generated further based on the at least one driving grade.

19. The method of claim 11, further comprising:
determining, based on the at least one driving behavior event, whether an accident occurred; and
upon determining that an accident occurred, sending a notification to at least one emergency responder service, wherein the notification indicates at least a location of the accident.

20. A non-transitory computer readable medium having stored thereon instructions for causing one or more processing units to execute a method, the method comprising:
receiving, from a driver user device including a plurality of sensors, sensor data captured by the plurality of sensors during a driving session, wherein the driver user device is affixed to a vehicle;
generating, based on the sensor data, at least one driving performance analytic;
determining, based on the at least one driving performance analytic, at least one driving behavior event, wherein each driving behavior event is further determined based on at least one driving behavior threshold;
generating, based on the at least one driving performance analytic and the at least one driving behavior event, a driving performance report for the driving session.
